(19) United States
(12) Patent Application Publication
(10) Pub. No.: US 2024/0292109 A1
(43) Pub. Date: Aug. 29, 2024

(54) IMAGE CAPTURING APPARATUS, IMAGE CAPTURING METHOD, AND STORAGE MEDIUM

(71) Applicant: CANON KABUSHIKI KAISHA, Tokyo (JP)

(72) Inventor: SEIGO KANEKO, Kanagawa (JP)

(21) Appl. No.: 18/443,598

(22) Filed: Feb. 16, 2024

(30) Foreign Application Priority Data
Feb. 28, 2023 (JP) 2023-029038

(51) Int. Cl. H04N 23/73; H04N 23/60; H04N 23/75; H04N 23/76; H04N 25/79

(52) U.S. Cl. CPC H04N 23/73; H04N 23/64; H04N 23/75; H04N 23/76; H04N 25/79

(57) ABSTRACT

In an image capturing apparatus, a voltage parameter relating to a reverse bias voltage of an avalanche photodiode of a photoelectric conversion element is controlled, an exposure parameter of the photoelectric conversion element is controlled, and image quality of an image that is obtained by the photoelectric conversion element is controlled by performing, in joint operation, an increase or decrease in a sensitivity of the photoelectric conversion element using the voltage parameter and an increase or decrease in an exposure amount or a digital gain of the photoelectric conversion element using the exposure parameter.

### BACKGROUND OF THE INVENTION

### Field of the Invention

The present invention relates to an image capturing apparatus, an image capturing method, a storage medium, and the like.

### Description of Related Art

In recent years, image capturing apparatuses that digitally count the number of photons that reach a single photon avalanche diode (SPAD), and output the counted value from a pixel to serve as a photoelectrically converted digital signal have been proposed.

Upon a photon becoming incident in a state in which a reverse bias voltage that is lower than the breakdown voltage has been applied to a SPAD, the electrons that have been photoelectrically converted are amplified, and avalanche amplification, during which a large electric current is flowed, occurs. It becomes possible to detect a quantity of light by counting the number of times that this avalanche amplification occurs.

In this context, it is known that the sensitivity of a SPAD changes based on the reverse bias voltage. In a SPAD, the larger the excess bias that is applied is in relation to the breakdown voltage, the higher the sensitivity becomes. For example, in Japanese Patent No. 6573186, a method is proposed in which dark portions and light portions are image captured by performing exposure by switching the reverse bias voltage.

In Japan Patent No. 6573186, it is possible to acquire images with different brightnesses by performing exposure by switching the reverse bias voltage. However, it would also be preferable to improve elements other than the brightness depending on the scene that is being image captured.

For example, in a scene according to a specific control such as a camera control (focusing, pan and tilt), application control (person counting, facial recognition), or the like, it would be preferable to acquire a high-resolution image (in which there is little noise, little subject blur, and little blur).

### SUMMARY OF THE INVENTION

An image capturing apparatus according to one aspect of the present invention comprises: at least one processor; and a memory coupled to the at least one processor, the memory storing instructions that, when executed by the at least one processor, cause the at least one processor to: control a voltage parameter relating to a reverse bias voltage of an avalanche photodiode of a photoelectric conversion element; control an exposure parameter of the photoelectric conversion element; and control an image quality of an image that is obtained by the photoelectric conversion element by performing, in joint operation, an increase or decrease in a sensitivity of the photoelectric conversion element using the voltage parameter, and an increase or decrease in an exposure amount or a digital gain of the photoelectric conversion element using the exposure parameter.

Further features of the present invention will become apparent from the following description of embodiments with reference to the attached drawings.

### BRIEF DESCRIPTION OF THE DRAWINGS

FIG. 1 is a diagram showing a configurational example of a photoelectric conversion element according to a First Embodiment.

FIG. 2 is a diagram showing a configurational example of a sensor board according to the First Embodiment.

FIG. 3 is a diagram showing a configurational example of a circuit board according to the First Embodiment.

FIG. 4 is a diagram showing a configurational example of an equivalent circuit for a signal processing circuit corresponding to a pixel of the photoelectric conversion element according to the First Embodiment.

FIG. 5 is a diagram that schematically shows the relationship between the operations and the output signal of an APD 201 according to the First Embodiment.

FIG. 6 is a functional block diagram of an image capturing apparatus according to the First Embodiment.

FIG. 7 is a flowchart showing an example of an image capturing method by a control unit 303 according to the First Embodiment.

FIGS. 8 (A) to (D) are diagrams showing examples of timings for changes to the voltage parameter and the exposure parameter according to the First Embodiment.

FIGS. 9 (A) to (C) are diagrams showing examples of timings for changes to the voltage parameter and the exposure parameter according to a Second Embodiment.

FIG. 10 is a flowchart showing an example of an image capturing method by a control unit 303 according to a Third Embodiment.

FIGS. 11 (A) to (D) are diagrams showing examples of timings for changes to the voltage parameter and exposure parameter according to a Third Embodiment.

FIG. 12 is a diagram showing a configurational example of an image capturing system comprising an image capturing apparatus 300 according to the first to Third Embodiments.

### DESCRIPTION OF THE EMBODIMENTS

Hereinafter, with reference to the accompanying drawings, favorable modes of the present invention will be described using Embodiments. In each diagram, the same reference signs are applied to the same members or elements, and duplicate descriptions will be omitted or simplified.

### First Embodiment

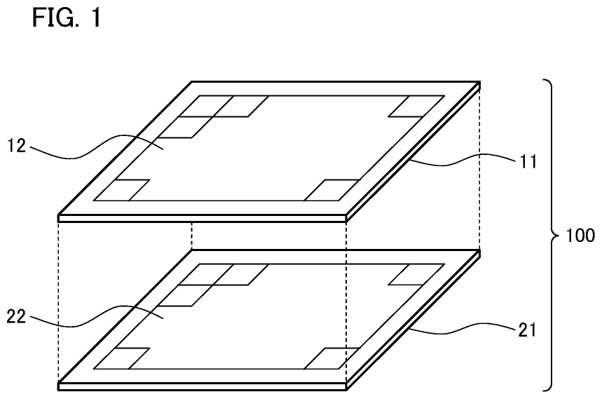

FIG. 1 is a diagram showing a configurational example of a photoelectric conversion element according to the First Embodiment. As is shown in FIG. 1, the photoelectric conversion element 100 of the First Embodiment is configured by the two layers of semiconductor boards of the sensor board 11 and the circuit board 21 being laminated and electrically connected, and this is a photoelectric conversion element with a so-called laminated structure.

However, this may also be a so-called non-laminated structure in which the configurations that are included in the sensor board and the configurations that are included in the circuit board have been arranged on the same semiconductor layer. The sensor board 11 includes a pixel region 12. The circuit board 21 includes a circuit region 22 in which a signal that has been detected in the pixel region 12 is processed.

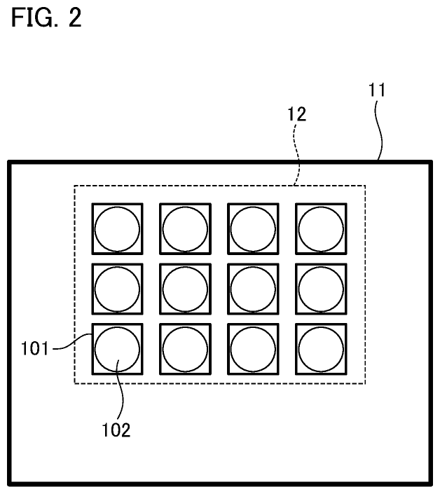

FIG. 2 is a diagram showing a configurational example of a sensor board according to the First Embodiment, and the pixel region 12 of the sensor board 11 includes pixels 101 that configure a plurality of rows and a plurality of columns by being arranged two dimensionally. Pixels 101 are provided with a photoelectric conversion unit 102 that includes an avalanche photodiode (below, an APD). Note that the number of rows and the number of columns for the pixel array that the pixel region 12 consists of are not limited to the example that is shown in FIG. 2.

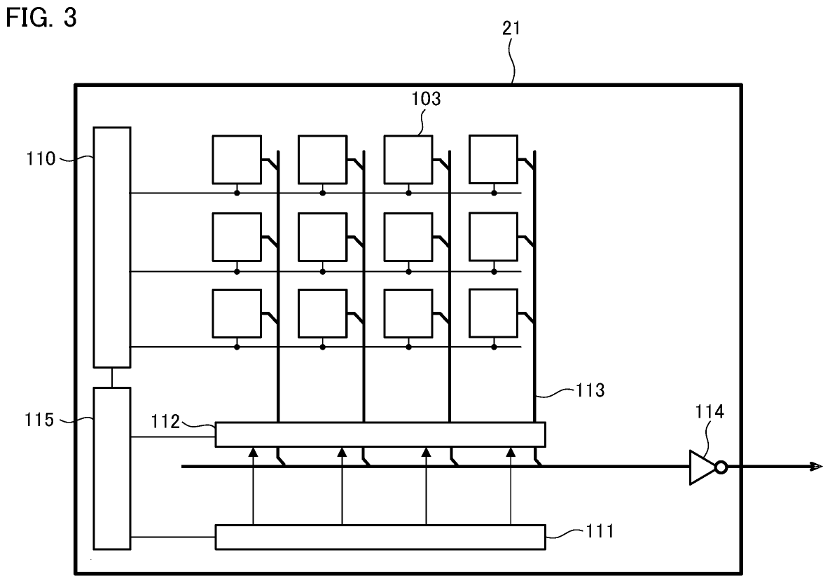

FIG. 3 is a diagram showing a configurational example of a circuit board according to the First Embodiment. The circuit board 21 has a signal processing circuit 103, which processes each electric charge that has been photoelectrically converted by the photoelectric conversion unit 102 of FIG. 2, a read-out circuit 112, a control pulse generating unit 115, a horizontal scanning circuit unit 111, a signal line 113, and a vertical scanning circuit unit 110.

The vertical scanning circuit unit 110 receives a control pulse that has been supplied from the control pulse generating unit 115, and supplies a control pulse to the plurality of pixels for each row. The logical circuits of a shift resistor and an address decoder are used in the vertical scanning circuit unit 110.

Signals that have been output from the photoelectric conversion units 102 of pixels are each processed in the corresponding signal processing circuit 103. The signal processing circuit 103 is provided with a counter and a memory, and digital values are held in the memory.

The horizontal scanning circuit unit 111 provides a control pulse that selects each column in order to the signal processing circuit 103 in order to read out a signal from the memory for each pixel on which a digital signal has been held. The signal for the column that has been selected is output to the signal line 113 from the signal processing circuit 103 for the pixel for the row that has been selected by the vertical scanning circuit unit 110. The signal that has been output by the signal line 113 is output to outside of the photoelectric conversion element 100 via the output circuit 114.

As is shown in FIG. 2, and FIG. 3, a plurality of signal processing circuits 103 are provided underneath the plurality of pixel regions 12. In addition, the vertical scanning circuit unit 110, the horizontal scanning circuit unit 111, the read-out circuit 112, the output circuit 114, and the control pulse generating unit 115 are arranged underneath a region that is between the sensor board 11 and the pixel region 12.

That is, the sensor board 11 has a pixel region 12 and a non-pixel region that has been arranged around the pixel region 12. In addition, the vertical scanning circuit unit 110, the horizontal scanning circuit unit 111, the read-out circuit 112, the output circuit 114, and the control pulse generating unit 115 are arranged under the non-pixel region.

Note that the arrangement of the signal line 113, and the arrangement of the read-out circuit 112 and the output circuit 114 are not limited to the example in FIG. 3. For example, the signal line 113 may also be arranged so as to extend in the direction of the rows, and the read-out circuit 112 may be arranged at the end of the extension of the signal line 113.

In addition, the functions of the signal processing circuit do not necessarily need to be provided to each photoelectric conversion unit, and this may also be a configuration in which one signal processing circuit is shared by a plurality of photoelectric conversion units, and signal processing is performed in order.

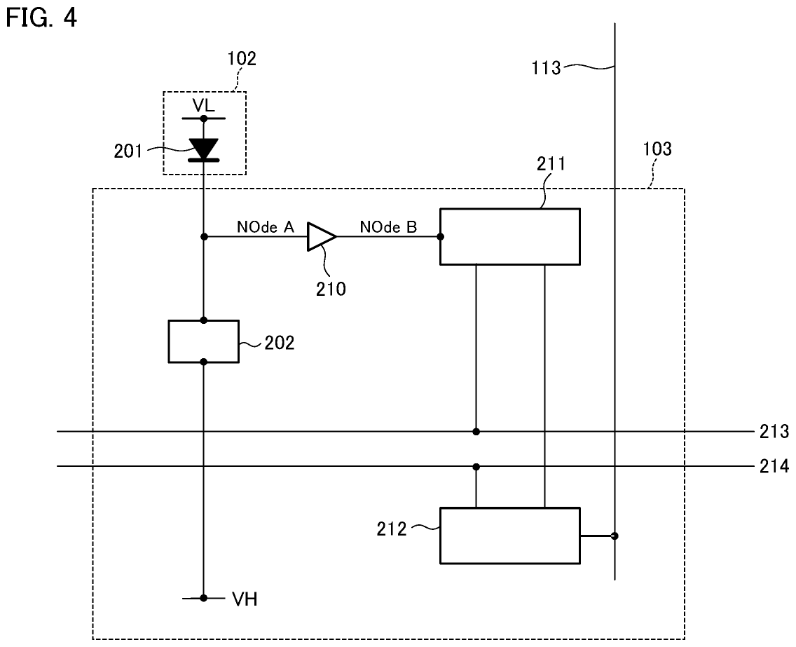

FIG. 4 is a diagram showing a configurational example of an equivalent circuit for the signal processing circuit corresponding to a pixel of the photoelectric conversion element according to the First Embodiment, and shows a pixel 101 and an equivalent circuit for the signal processing circuit 103 corresponding to this pixel 101.

The photoelectric conversion element 100 has an avalanche photodiode (APD) 201, and the APD 201 generates an electric charge pair according to incident light using photoelectric conversion. The anode of the APD 201 is connected to a power source line that supplies a drive voltage VL.

In addition, the cathode of the APD 201 is connected to a power source line that supplies a drive voltage VH that is higher than the drive voltage VL via a quenching element 202. A reverse bias voltage VR is supplied to the anode of the APD 201 such that the APD 201 performs an avalanche amplification operation. In this context, the reverse bias voltage VR is acquired using the Formula 1 below.

$$VR = VL - VH \qquad ( Formula 1 )$$

By making this a state in which such a reverse bias voltage VR has been supplied, the electric charge caused by incident light causes avalanche multiplication, and an avalanche electric current is generated.

Note that in a case in which the reverse bias voltage VR is supplied, there is a Geiger mode in which the APD is operated at a voltage difference in which the voltage difference between the anode and the cathode is larger than the breakdown voltage, and a linear mode in which the APD is operated at a voltage difference in which the voltage difference for the anode and the cathode is in the vicinity of or less than the breakdown voltage. An APD that is made to operate in Geiger mode is referred to as a SPAD. In the case of a SPAD, the drive voltage VL is, for example, −30V, and the drive voltage VH is, for example, 1V.

The quenching element 202 is connected to the power source that supplies the drive voltage VH and to the cathode of the APD 201. The quenching element 202 functions as a load circuit (quenching circuit) at the time of signal multiplication by avalanche multiplication, controls the voltage that is supplied to the APD 201, and performs a quenching operation that controls the avalanche multiplication.

In addition, the quenching element 202 performs a re-charging operation that returns the voltage that is supplied to the APD 201 to the drive voltage VH by flowing an electric current for the amount that was voltage dropped during the quenching operation.

The signal processing circuit 103 has a waveform shaping unit 210, a counter circuit 211, and a selecting circuit 212. In FIG. 4, an example is shown in which the signal processing circuit 103 has the waveform shaping unit 210, the counter circuit 211, and the selecting circuit 212. However, it is sufficient if the signal processing circuit 103 has at least one of the waveform shaping unit 210, the counter circuit 211, or the selecting circuit 212.

The waveform shaping unit 210 adjusts voltage changes to the cathode of the APD 201 that are obtained at the time of photon detection, and outputs a pulse signal. For example, an inverter circuit is used as the waveform shaping unit 210. Although an example has been shown in FIG. 4 in which one inverter has been used as the waveform shaping unit 210, a circuit in which a plurality of inverters have been series connected may also be used, or another circuit that has waveform shaping effects may also be used.

The counter circuit 211 counts the pulse signals that have been output from the waveform shaping unit 210, and holds a count value. In addition, when a control pulse RES has been supplied via a signal line 213, the count value that was held in the counter circuit 211 is reset.

A control pulse SEL is supplied to the selecting circuit 212 from the vertical scanning circuit unit 110 of FIG. 3 via the drive line 214 of FIG. 4 (not illustrated in FIG. 3). The selecting circuit 212 includes, for example, a buffer circuit for outputting a signal, or the like, and selectively outputs an output signal from the counter circuit 211 of a pixel to the signal line 113 according to the control pulse SEL.

Although an example has been shown in FIG. 4 in which the output signal is switched by the selecting circuit 212, a switch such as a transistor or the like may be disposed between the quenching element 202 and the APD 201, and between the photoelectric conversion unit 102 and the signal processing circuit 103, and the electrical connection may be switched on and off. In the same manner, the supply of the drive voltage VH or the drive voltage VL that are supplied to the photoelectric conversion unit 102 may also be electrically switched on and off using a switch such as a transistor or the like.

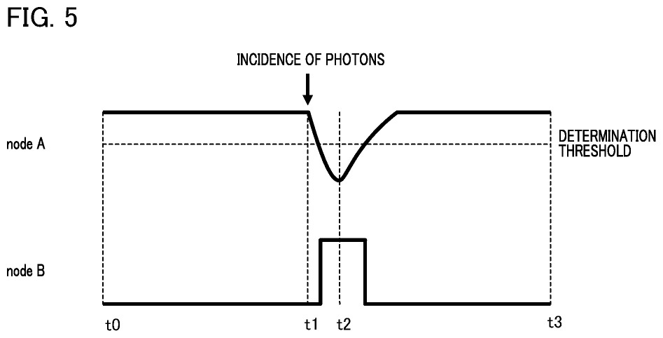

FIG. 5 is a diagram that schematically shows the relationship between the operations and the output signal of the APD 201 in the First Embodiment. An input side of the waveform shaping unit 210 is made a nodeA, and an output side thereof is made a nodeB. During the time t0 to the time t1, the potential difference of VH-VL is applied to the APD 201.

Upon photons becoming incident on the APD 201 during the time t1, avalanche multiplication occurs in the APD 201, an avalanche multiplication current is flowed through the quenching element 202, and the voltage for the nodeA is dropped.

If the voltage drop amount further increases and the potential difference that is applied to the APD 201 becomes smaller, the avalanche multiplication of the APD 201 is stopped, and the voltage level for the nodeA is not dropped by more than a fixed amount, as during the time t2.

After this, during the period from the time t2 to the time t3, a current that compensates for the voltage drop amount from the drive voltage VL is flowed through the nodeA, and during the time t3, the nodeA becomes statically determinate at the original potential level. At this time, the portion of the output waveform in the nodeA that has become less than a predetermined determination threshold is waveform shaped by the waveform shaping unit 210 and output in the nodeB to serve as a pulse signal. In addition, there is a temperature dependence in the breakdown voltage for the APD 201, and therefore, it is preferable that the reverse bias voltage VR is set in joint operation with the temperature. Therefore, in the present embodiment, the temperature of the photoelectric conversion element 100 is detected, and the reverse bias voltage VR is corrected according to the temperature dependence for the breakdown voltage.

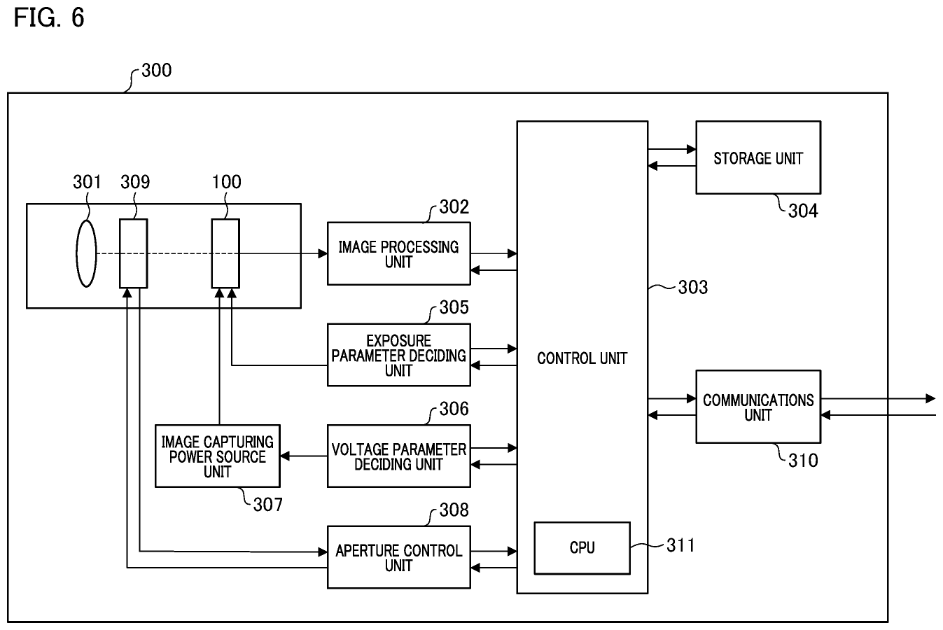

FIG. 6 is a functional block diagram for the image capturing apparatus according to the First Embodiment. Note that a portion of the functional blocks that are shown in FIG. 6 are realized by a computer program that has been stored on a memory (the storage unit 304) that serves as a storage medium being executed by the CPU 311, which serves as a computer that is included in the control unit 303.

However, a portion or the entirety thereof may also be made to be realized using hardware. As this hardware, an application-specific integrated circuit (ASIC), a processor (a reconfigurable processor, a DSP), or the like can be used. In addition, each of the functional blocks that is shown in FIG. 6 do not need to be encased in the same body, and may also be configured by separate apparatuses have been connected to each other via signal paths.

The image capturing apparatus 300 has a photoelectric conversion element 100, an image forming optical system 301, an image processing unit 302, a control unit 303, a storage unit 304, an exposure parameter deciding unit 305, and a voltage parameter deciding unit 306. In addition, the image capturing apparatus 300 also has an image capturing power source unit 307, an aperture control unit 308, an aperture mechanism 309, a communications unit 310, and the like. Note that a portion of the configuration and functions of the image capturing apparatus 300 may also be provided on the side of an external apparatus (a client apparatus) that is not illustrated, instead of by the image capturing apparatus 300.

The image forming optical system 301 is configured from a plurality of lenses and a lens barrel member that holds these, and makes an image become incident on the photoelectric conversion element 100. In addition, it is possible to control zooming and focus using a drive motor or the like. This may further have a configuration that is able to add or remove an infrared cut filter or the like, which is a filter that either allows specific wavelengths to pass therethrough, or dampens these.

The aperture mechanism 309 is a mechanism for adjusting the quantity of light that becomes incident on the photoelectric conversion element 100. The aperture amount is controlled by the aperture control unit 308. That is, the aperture mechanism 309 controls the aperture value (the F number) for the optical system that makes an image become incident on the photoelectric conversion element. Note that the photoelectric conversion element 100 has, for example, an on-chip color filter for an RGB Bayer array.

The image that has been formed by the image forming optical system 301 is image captured and AD converted in the photoelectric conversion element 100 and output to serve as digital pixel data. In addition to the image generation and correction processing in the image processing unit 302, processing such as black level correction, gamma curve adjustment, noise reduction, white balance correction, color conversion, data compression, and the like is performed on the pixel data, and final image data is generated.

Note that in the present embodiment, the data that is input into the image processing unit 302 is referred to as pixel data, and the data that is output from the image processing unit 302 is referred to as image data.

In addition, an AE evaluation value for use in AE (auto exposure) is calculated from the image data that has been generated in the image processing unit 302. The aperture, exposure time (image capturing time), and the digital gain are adjusted based on the above AE amount such that the luminance level for the image data becomes a suitable level. In addition, it is also possible to change the brightness of the pixel data that is output from the photoelectric conversion element 100 using digital gain in the image processing unit 302.

The storage unit 304 is a storage medium that can temporarily store and read out the image data that has been output by the image processing unit 302. This is further used as a storage area for the computer program that is executed by the CPU 311 of the control unit 303, which will be described below, a storage area for each type of parameter, and a work area for programs that are being executed.

The communications unit 310 streams image data to an external apparatus (a client apparatus) that is not illustrated after having converted this to a format conforming to a communication protocol. More specifically, compression encoding processing such as H.264, H.265 or the like is performed.

In addition, the communications unit 310 receives setting commands and the like for each type of parameter from the external apparatus, and also transmits responses to the external apparatus at the same time as outputting these to the control unit 303. The external apparatus is able to send zoom and focus commands or the like to the image capturing apparatus 300, and in addition, it is possible to enlarge/shrink the display of the image in a display unit of the external apparatus that has received the image that is being streamed.

In addition, the image capturing apparatus 300 is able to acquire operation information and control information for the external apparatus. Note that in the present embodiment, a system that includes an external apparatus and the image capturing apparatus 300 is referred to as an image capturing system.

The exposure parameter deciding unit 305 decides the exposure parameter for the image capturing apparatus 300. In the present embodiment, the exposure parameters include at least one of the exposure time (photoelectric conversion time), the digital gain, or the aperture value for the photoelectric conversion element, and at least one of a transition amount (a change amount) or a transition time (a number of transitions, a transition interval, or a transition timing).

Note that the digital gain in this context indicates a digital gain in the image processing unit 302 that processes the image signal that has been output from the photoelectric conversion element, and the aperture value indicates the aperture value for the optical system that makes an image become incident on the photoelectric conversion apparatus.

In this context, the exposure parameter deciding unit 305 functions as an exposure parameter control unit configured to control exposure parameters such as the exposure time of the photoelectric conversion element or the like according to an event type. Note that in the following embodiments, transition and change are used as having the same meaning.

The voltage parameter deciding unit 306 decides the reverse bias voltage VR for the photoelectric conversion element 100. The voltage parameters include either the transition amount or transition time (the number of transitions, the transition interval, or the transition timing) of the reverse bias voltage VR.

The voltage parameter deciding unit 306 changes the image capturing power source unit 307 to the voltage parameters that have been determined. In this context, the voltage parameter deciding unit 306 functions as an exposure parameter control unit configured to control the reverse bias voltage that is applied to the avalanche photodiode. In addition, the voltage parameter deciding unit 306 decides the transition amount or the transition time for the voltage parameter according to a type of event.

The image capturing power source unit 307 is provided with a circuit for variably controlling the output voltage that is supplied to the photoelectric conversion element 100. In the present embodiment, although it possible to adjust the output voltage by re-writing the register for a control IC that has been provided to the image capturing power source unit 307, this is not limited thereto. For example, a plurality of power sources may also be supplied, and it may be made possible to select a power source that will supply power to the photoelectric conversion element 100 from among the plurality of power sources based on a command from the control unit 303.

The aperture control unit 308 controls the aperture mechanism 309 such that the aperture becomes the aperture amount that was decided in the exposure parameter deciding unit 305. The control unit 303 is equipped with the CPU 311, which serves as a computer, and integrally controls each configurational element of the image capturing apparatus 300 by executing a computer program that has been stored on the storage unit 304, which serves as a storage medium, using this CPU 311. In addition, the control unit 303 performs reception and transmission commands for the settings and data for each type of parameter.

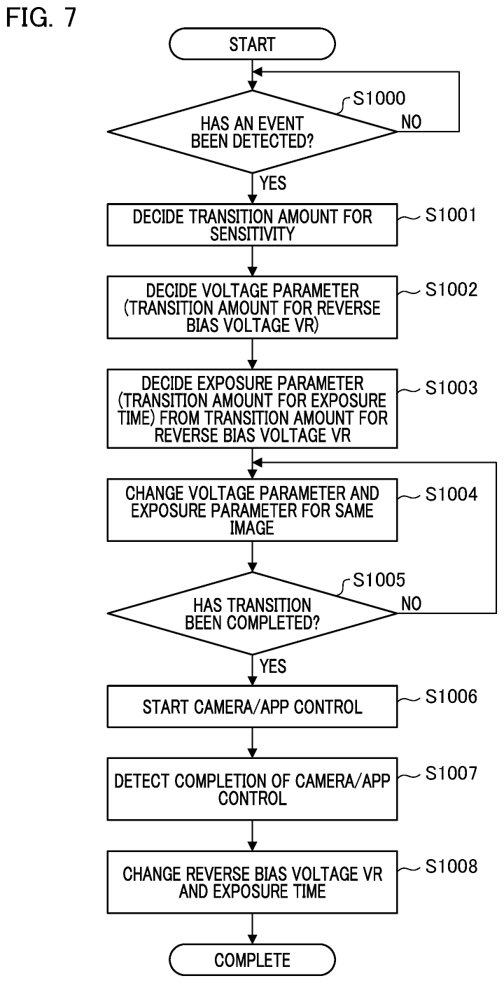

FIG. 7 is a flowchart showing an example of an image capturing method according to the control unit 303 according to the First Embodiment. Note that the operations for each step of the flowchart in FIG. 7 are performed in order by the CPU or the like that serves as a computer inside of the control unit 303 executing the computer program that has been stored on the memory. In addition, the flow in FIG. 7 is cyclically executed at a predetermined cycle.

First, during step S1000, the control unit 303 performs a determination as to whether or not an event has been detected. An example will be explained in the present embodiment for a case in which the event is an autofocus command for the image capturing apparatus 300. Note that step S1000 in this context functions as an event detection step (an event detecting unit) that detects an event.

In a case in which the image capturing apparatus 300 has received an autofocus command from the external apparatus of the user via the communications unit 310, it is determined that an event has been detected (yes), and the processing proceeds to step S1001. In a case in which no event has been detected, the processing returns to step S1000, and stands by until an event is detected.

During step S1001, the control unit 303 decides the transition amount for the sensitivity. The transition amount for the sensitivity is decided by the type of the event or the value for the pixel data that is being image captured. In the present embodiment, an example will be explained in which the event is an autofocus command, and autofocus is smoothly performed by acquiring a high resolution image in which the S/N has been improved.

That is, it is assumed that the sensitivity is raised by, for example, 12%, by changing the reverse bias voltage VR in order to improve the S/N.

Note that in the present embodiment, it is made such that in an environment in which a subject that is being image captured is bright and it is easy for overexposure to occur, the sensitivity is not increased by changing the reverse bias voltage. Therefore, the exposure time before the transition of the reverse bias voltage is not saturated on the overexposed side (the side for which the exposure time is short), and the sensitivity is raised by transitioning the reverse bias voltage only in a case in which there is a one level or more margin until saturation.

In a case in which there is not a one level or more margin until saturation, that is, in a case in which the brightness of the subject is at or above a predetermined level, the exposure time is less than a predetermined time, or the aperture value is at or above a predetermined value, the transition of the reverse bias voltage is not performed as a voltage parameter, and the transition amount is made 0. In a case in which the transition amount is 0, the present flow may also be completed at this time. In addition, in a case in which the current (before the transition of the reverse bias voltage) transition amount is 0, the reverse bias voltage VR is made −31.0 V.

In addition, in the present embodiment, it is assumed that, for example, AGC (auto gain control) is performed by digital gain in the image processing unit 302. In this case, it is expected that when the digital gain is small, the subject is sufficiently bright, and the S/N is sufficiently high.

Therefore, in a case in which the digital gain is less than the predetermined value, it may also be made such that the transition of the reverse bias voltage in the present embodiment is not performed. Note that in the present embodiment, it is possible to change the digital gain using a control from the control unit 303.

During step S1002, the control unit 303 decides the voltage parameter. Before autofocus is performed, an image is generally blurred, and therefore, in many cases, even if the image quality (the brightness and noise) is slightly changed by changing the reverse bias voltage VR, this will not stand out.

Therefore, the time until autofocus is started is shortened by sharply performing the transition for the reverse bias voltage VR. In order to do so, the transition amount for the reverse bias voltage (12% of the sensitivity) is made to be transitioned over, for example, one transition.

Note that there is a linear characteristic in the transition amount ΔX [V] of the reverse bias voltage and the transition amount ΔY [%] for the sensitivity of the photoelectric conversion element 100. If the coefficient for the linear characteristic is made A, this is shown by the formula 1 below.

$$- △ X = A x △Y \qquad ( Formula 1 )$$

For example, in a case in which ΔY [%] is approximately 6%, ΔX [V] is −100 mV, and in a case in which ΔY [%] is approximately +2%, ΔX[V] is −200 mV. Portions that deviate from the linear characteristic may also be suitably corrected.

In this context, in order to increase the sensitivity by 12%, the transition amount ΔX [V] for the reverse bias voltage VR is made −200 mV. In addition, if the reverse bias voltage from before the transition is made VRa, and the reverse bias after the transition is made VRb, this is shown by the Formula 2 below.

$$VRb = VRa + △ X \qquad ( Formula 2 )$$

Therefore, when the reverse bias voltage VRa from before the transition is −31.0 [V], the reverse bias voltage VRb from after the transition is shown using the formula 3 below.

$$VRb = - 31. - 0.2 = - 31.2 [ V ] \qquad ( Formula 3 )$$

During step S1003, the control unit 303 decides the exposure parameter based on the voltage parameter. In the present embodiment, in order to raise the evaluation value for the focus (the degree of precision), the S/N is raised by decreasing the digital gain by the increase amount for the sensitivity due to transitioning the reverse bias voltage. Therefore, the digital gain is made −12% of the current value. In addition, the number of transitions is also made one time, the same as for the voltage parameter.

During step S1004, the control unit 303 performs the changes for the voltage parameter and the exposure parameter. The changes for the voltage parameter and the exposure are synchronized in the control unit 303, and are changed for an image from the same frame. That is, the voltage parameter and the exposure parameter are both controlled for the same frame. Note that the transition for the voltage parameter (change) is controlled so as to be completed during the blank period (blanking period) before the start of the exposure period.

In this context, step S1004 functions as a voltage parameter control step (voltage parameter control unit) that controls the voltage parameter in relation to the reverse bias voltage for an avalanche photo diode of an image capturing element. In addition, this also functions as an exposure parameter control step (exposure parameter control unit) that controls an exposure parameter of a photoelectric conversion apparatus.

Step S1004 further functions as a control step (control unit) that performs, in joint operation, an increase or decrease in a sensitivity of the photoelectric conversion element using the voltage parameter and an increase or decrease in the exposure amount or the digital gain of a photoelectric conversion apparatus using an exposure parameter. In addition, the image quality of an image that is obtained from the photoelectric conversion element is controlled according to an event type by changing the voltage parameter and exposure parameter according to the event type using this step S1004.

It is thereby possible to perform image capturing with the same sensitivity for all exposure periods. In addition, the change to the digital gain that serves as the exposure parameter is performed on pixel data that has been output after the reverse bias voltage change. In this context, the reverse bias voltage is changed to VRb=−31.2V, and the digital gain is decreased by 12%. By doing so, it is possible to control sharp changes in the brightness of an image due to the transition of the reverse bias voltage.

During step S1005, the control unit 303 performs a determination as to if the transition for the voltage parameter and the exposure parameter has been completed. In a case in which the transition is made one time, the transition is completed in one frame, and the processing proceeds to step S1006. In the case in which the number of transitions is made a plurality of times, step S1004 is repeated until the transitions are completed.

During step S1006, the control unit 303 starts the camera/application control. In this context, autofocus, which is a camera control, is performed. An autofocus may be controlled after the transition for the voltage parameter and the exposure parameter is completed.

During step S1007, the control unit 303 detects the completion of the camera/application control. In this context, the control unit 303 determines the completion of autofocusing.

During step S1008, the control unit 303 returns the voltage parameter and the exposure parameter by the same amount as the transition amount that was performed in step S1004 after the completion of the autofocus control. The event is already completed, and therefore, the need to sharply return the transition amount is low. Therefore, the transition amount may be segmented and returned by performing the transmission over a plurality of times.

Due to this, during step S1008, the brightness and noise of the image do not suddenly change, and therefore, it is possible to suppress a sense of unnaturalness for the user. In addition, at this time, it is possible to suppress changes in the brightness of the image data by controlling the voltage parameter and the exposure parameter at the same time in the same manner as for step S1004.

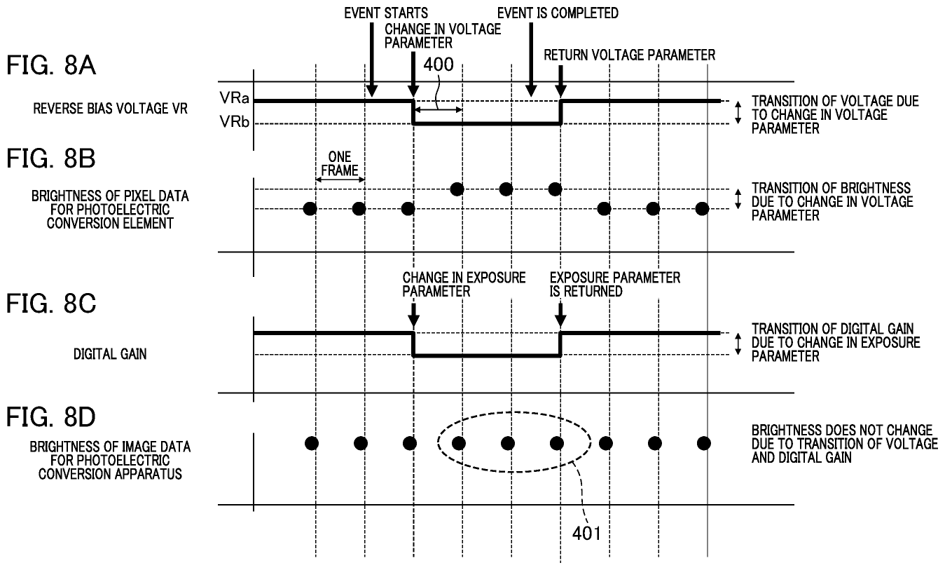

Next, the timing for changing the voltage parameter and the exposure parameter will be explained with reference to FIG. 8. FIGS. 8 (A) to (D) are diagrams showing examples of timings for changing the voltage parameter and the exposure parameter according to the First Embodiment.

FIG. 8 (A) is a diagram showing a waveform for the reverse bias voltage, FIG. 8 (B) is a diagram showing a change in brightness for pixel data that is read out from the photoelectric conversion element 100, FIG. 8 (C) is a diagram showing a waveform for the digital gain, and FIG. 8 (D) is a diagram showing a change in the brightness for an image that is read out from an image capturing apparatus. In FIGS. 8 (A) to (D), the horizontal axis represents time.

In addition, the image capturing interval for one frame is shown using a dotted line. In addition, after the detection of an event start, the frame for which the voltage parameter and the exposure parameter are changed is shown as a frame 400.

The transition for the reverse bias voltage VR will be explained with reference to FIG. 8 (A). Directly before the next frame 400 after the detection of the event start has been detected, the voltage parameter is changed from VRa to VRb. It is preferable that the change (transition) to the voltage parameter at this time is completed during the blank period directly before the exposure period for the frame 400 that will be image captured.

The brightness for the pixel data that is read out from the photoelectric conversion element 100 that has been image captured during the frame 400 is made brighter by increasing the sensitivity by changing the voltage parameter. In contrast, as is shown in FIG. 8 (C), the digital gain is decreased by the amount that the sensitivity was raised. The digital gain is calculated in relation to the pixel data that has been image captured. Therefore, the digital gain is decreased at the timing at which the pixel data from the photoelectric conversion element 100 for the frame 400 became bright.

As is shown in FIG. 8 (D), in the image data that is read out from the image capturing apparatus 300, the digital gain is transitioned in order to negate a change in brightness due to the transition of the reverse bias voltage, and therefore the brightness for the image data becomes approximately constant. In addition, in contrast to the sensitivity for the image for the period 401, during which the voltage parameter is changed, becoming higher, this becomes a high-quality image with a good S/N as the digital gain is suppressed. It is thereby possible to perform image capturing of a scene from the start until the finish of an event with a high image quality.

In the present embodiment, as was explained above, an example is explained of a case in which the event is an autofocus command for an image capturing apparatus 300, and as the focus control, for example, contrast AF (autofocus) is explained.

The image capturing apparatus 300 calculates an evaluation value for the focus by calculating a contrast ratio from the pixel data that was image captured by the photoelectric conversion element 100. The image capturing apparatus 300 decides the optimal focus position by searching for a focus position for which the focus evaluation value is at its peak while changing the focus position.

Note that although an example has been explained with contrast AF (autofocus) as the focus control, the present invention is not limited thereto, and for example, this may also be autofocus that uses a phase difference AF format.

Note that the flow that is shown in FIG. 7 may also be performed by a CPU on the side of the image capturing apparatus 300, or it may also be performed by a CPU on the side of an external apparatus (a client apparatus) for controlling the image capturing apparatus 300.

Note that in the above explanation, although an example has been explained in which the brightness of the subject after the change of the voltage parameter and the exposure parameter does not change, in a case in which the brightness of the subject has changed, the digital gain and the exposure time may also be changed according to this change. However, when returning the voltage parameter and the exposure parameter, the transition amount does not change.

In addition, although it is preferable that the change for the voltage parameter is completed before the exposure of the frame that is being image captured, the voltage parameter may also be changed during the exposure period, In this case, it is preferable if the fluctuation amount for the sensitivity due to the change in the reverse bias voltage during the exposure period is corrected so as to be negated by the exposure parameter and the digital gain.

That is, in a case in which the rise and fall of the waveform in FIG. 8 (A) has a slope, it is sufficient if a slope is added to the rise and fall in the waveform in FIG. 8 (C) as well to match this.

### Second Embodiment

In the First Embodiment, an example was explained in which the changes in the reverse bias voltage were canceled out by a digital gain serving as an exposure parameter. However, in the Second Embodiment, an example will be explained in which this is canceled out using exposure time and aperture to serve as the exposure parameter. The control method is the same for the exposure time and the aperture, and therefore, in this context, an explanation will be given with the exposure time as an example.

While the digital gain is a parameter in relation to the output of the pixel data, the exposure time is a parameter relating to the input of the pixel data. In either of these cases, the point that changes are made to image data in which the sensitivity has been increased or decreased by performing a change to the voltage parameter such that the brightness is corrected by the exposure parameter is the same.

In the Second Embodiment, the differences from the First Embodiment are the point that the exposure time is changed to serve as the exposure parameter, and the point that the change in the brightness of the image is determined, this is made a moving body detection event, and image recognition such as facial recognition or the like is performed.

The flow for the Second Embodiment is similar to FIG. 7, and the flow for the Second Embodiment will be explained using FIG. 7. During step S1000 of FIG. 7, in a case in which there is a change to the brightness of an image that is being continuously image captured that is at or above a predetermined value, this is detected as a moving body detection event, and the control unit 303 determines yes.

During step S1002, the control unit 303 decides the voltage parameter in the same manner as in the First Embodiment, and decides the exposure parameter during step S1003. The exposure parameter is the transition amount and transition time (number of transitions, transition interval) for the exposure time.

During step S1004, the control unit 303 changes the voltage parameter and the exposure parameter. In addition, during step S1005, the control unit 303 determines whether or not the transition has been completed in the same manner as in the First Embodiment, and if this is a yes, during step S1006, performs image recognition such as facial recognition or the like on a region of the moving body that has been detected.

During step S1007, the control unit 303 detects the completion of the facial recognition (image recognition), and during step S1008, returns the voltage parameter and the exposure parameter to their original state in the same manner that was explained in the First Embodiment.

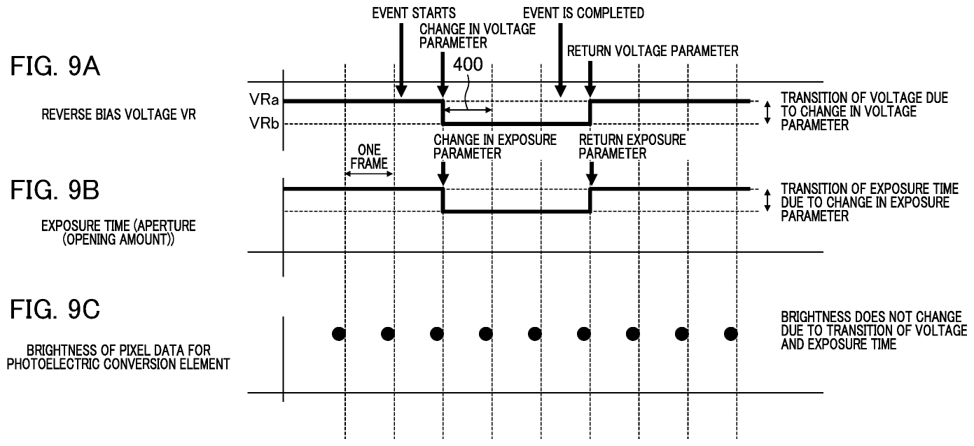

Next, the timing for the change to the voltage parameter and the exposure parameter will be explained with reference to FIG. 9. FIGS. 9 (A) to (C) are diagrams showing examples of timings for changing the voltage parameter and the exposure parameter according to the Second Embodiment.

FIG. 9 (A) is a diagram showing a waveform for the reverse bias voltage, FIG. 9 (B) is a diagram showing the changes in the exposure time and the aperture opening amount due to the change in the exposure parameter, FIG. 9 (C) is a diagram showing changes in the brightness of the image that is read out from the image capturing apparatus, and in FIGS. 9 (A) to (C), the horizontal axis represents time.

As is shown in FIGS. 9 (A), and (B), the changes to the voltage parameter and the exposure parameter are performed before the start of exposure during a frame after the start of the event. This is because whereas the digital gain in the First Embodiment is processing on the pixel data from after exposure, the exposure time is a parameter that muse be changed at the time of exposure.

FIG. 9 shows an example of the reverse bias voltage VR and the exposure time being transitioned (changed) at the same time. In addition, different than in FIG. 8, in FIG. 9, the brightness of the pixel data that is read out from the photoelectric conversion element does not change. Note that in the image from the period in which the voltage parameter is changed, the exposure time is shortened by the amount for which the sensitivity is high.

Specifically, within the frame period, the exposure time (photoelectric conversion time) is made shorter by shortening the count period from when the counter circuit 211 is reset until the count is completed. Therefore, this becomes a high-quality image with little subject blur, and it is possible to perform high-quality image capturing of a scene in which a moving body has been detected, and it is possible to perform high precision image recognition (subject recognition).

In this manner, in the Second Embodiment, it becomes possible to acquire an image with a high image quality in which subject blur has been suppressed by setting the exposure time t0 be short by a sensitivity amount according to a transition for the reverse bias voltage. It is thereby possible to acquire an image with a high image quality of a moving body that has been detected by a moving body detection event, and it is possible to increase the image recognition precision in relation to this moving body.

Note that although an example has been given in the Second Embodiment in which facial recognition (image recognition) is performed during step S1006 of FIG. 7, just image capturing or recording of a moving body without subject blur may also be performed, and the processing that performs the control such as the facial recognition (image recognition) or the like may also be omitted.

In this case, during step S1007, in a case in which the moving body can no longer be detected, or after a predetermined amount of time has elapsed, the detection of the event is completed. In this manner, even by just acquiring an image with a high image quality directly after an event has been detected, without performing a camera control or application control such as facial recognition (image recognition) or the like, when the user confirms the image, it is possible for them to confirm an image with a high image quality. Therefore, it becomes easy to perform confirmation, even for a relatively small subject or for small movements.

Note that although in FIG. 9, an example has been explained in which the exposure time is changed as the exposure parameter, it is possible to apply this in the same manner to any parameter related to exposure. For example, in a case in which aperture is changed instead of exposure time, this is also transitioned in the same manner as the exposure time that was shown in FIG. 9.

In addition, in a case in which aperture is controlled, it is also possible to change the depth of field by changing the sensitivity by transitioning the reverse bias voltage. Note that it may also be made such that both the exposure time and the aperture are changed according to an exposure program diagram that has been set in advance to serve as the exposure parameter.

In the First Embodiment and the Second Embodiment, after an event has been detected, control was then performed in which the sensitivity was increased by transitioning the reverse bias voltage. However, control may also be performed so as to decrease the sensitivity. That is, in the First Embodiment and the Second Embodiment, an example has been given in which the reverse bias voltage has been changed from, for example, −31.0 V to, for example −31.2V, and the sensitivity was thereby increased.

However, the sensitivity may also be decreased by changing the reverse bias voltage from, for example −31.0 V to, for example −30.8V. Making the sensitivity smaller in this manner is effective in, for example, cases in which the user would like to obtain a light-track image using long second photography, portrait image capturing in which the aperture has been made close to an open aperture, cases in which an image capturing apparatus is transitioned to an energy saving mode by the detection of an event, or the like.

In addition, in a case in which the absolute value for the reverse bias has been increased (−31.0 V→−31.2V) in order to increase the sensitivity, the energy consumption will also increase as the absolute value for the voltage increases. Therefore, during step S1007 of FIG. 7, a time limit of a predetermined time (for example, 60 seconds) may also be set in the detection of the end of an event. That is, it may be made such that after the predetermined time has elapsed, the transition for the voltage parameter is returned.

By doing so, even in a case in which an event does not end (for example, in a state in which moving body continues to exist), it may be made such that the change to the reverse bias voltage is completed after the predetermined time has elapsed. In addition, in a case in which the event detection frequency is high, it may also be made such that the detection of events is performed at a predetermined interval (for example, every 60 seconds). In addition, although 60 seconds has been given as an example in this context, the detection interval for an event may also be set as a different time interval according to the type of event.

In addition, in a case in which it is possible to predict the amount of time that is necessary to control the camera/application from step S1006 to step S1007 in FIG. 7, the transition amount for the reverse bias voltage may also be set based on this predicted control time.

For example, the relationship between the control time and the transition amount for the reverse bias voltage is made an inverse relationship, and the longer that the control time during step S1007 in FIG. 7 becomes, the smaller that the transition amount for the reverse bias voltage will become. It is thereby possible to prevent increases in the energy consumption due to the control time increasing. In addition, the transition amount for the reverse bias voltage may also be decided from the event frequency instead of the control time.

### Third Embodiment

The First Embodiment and the Second Embodiment explained examples in which the exposure parameter and the voltage parameters are controlled in synchronization by the control unit 303. In addition, in the First Embodiment and the Second Embodiment, the exposure parameter is decided according to the voltage parameter.

However, in the Third Embodiment, the exposure parameter and the voltage parameter are controlled asynchronously. That is, the transition of the voltage parameter and the transition of the exposure parameter are performed asynchronously. In addition, in the Third Embodiment, the transition amount and the transition time (the number of transitions, the transition interval) for the voltage parameter are decided based on the exposure parameter.

For example, during image capturing of a video image, regardless of there being no changes in the subject, if the brightness of the image is suddenly changed, visibility will become poor. Therefore, the control unit 303 gradually transitions the brightness over a plurality of frames using digital gain, the exposure time, or the aperture.

For example, an example is explained in which in a case in which the brightness is changed by one level according to the exposure parameter, this is transitioned over, for example, 1 s (second). If the transition speed for the exposure parameter at this time is expressed as a transition speed Vex using the ratio of the number of levels of the sensitivity and the transition time, it can be expressed as in the Formula 4 below.

$$( Formula 4 )$$

$$Transition speed Vex [ level / s ] = number of levels of sensitivity [ level ] / time [ s ] = 1$$

At this time, if the smallest transition amount by which the exposure for the image capturing apparatus 300 can be changed is made 0.1 levels, the smallest transition time in order to perform the change for the exposure becomes 0.1 s. In addition, if the image capturing apparatus captures a video image at 30 fps (frames per second), the smallest transition time (number of frames) for performing the change to the exposure becomes 3 frames.

In addition, it is possible to express the number of levels using the Formula 5 and Formula 6 below, and in a case in which, for example, the sensitivity has increased by 12 [%], this becomes brighter by 0.16 levels.

$$Number of levels [ level ] = Log 2 ( magnification ) \qquad ( Formula 5 )$$

$$Number of levels [ level ] = Log 2 ( 1.12 ) = 0.16 \qquad ( Formula 6 )$$

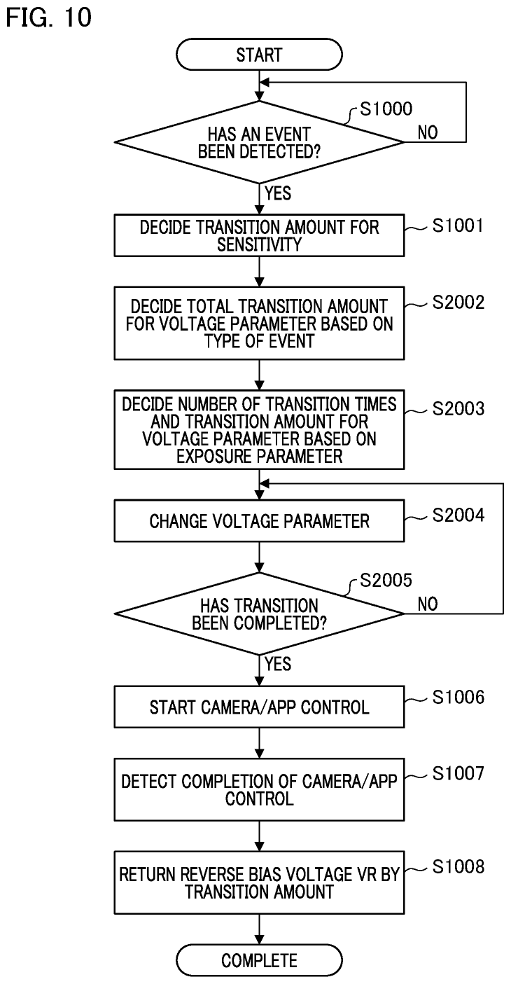

Next, the process for a case in which the voltage parameter and the exposure parameter are asynchronous will be explained with reference to FIG. 10. FIG. 10 is a flowchart showing an example of an image capturing method by the control unit 303 according to the Third Embodiment.

Note that the operations for each step of the flowchart in FIG. 10 are performed in order by a CPU or the like that serves a s computer inside of the control unit 303 executing a computer program that has been stored on a memory. In addition, the flow in FIG. 10 is executed cyclically at a predetermined cycle.

In FIG. 10, the steps with the same numbers as the steps in FIG. 7 show the same processing, and explanations thereof will be omitted. During step S2002, the transition amount for the reverse bias voltage VR is decided in the same manner as in the First Embodiment. In this context, an example is explained in which the transition amount for the sensitivity is made, for example 12%, the same as in the First Embodiment. However, in the Third Embodiment, the total transition amount for the voltage parameter is decided based on the type of event.

During step S2003, the voltage parameter is decided based on the exposure parameter. Therefore, when changing the exposure, which is the exposure parameter, the smallest transition amount and the smallest transition time that can be set will be referenced.

First, it is determined if the transition amount for the reverse bias voltage is less than the smallest transition amount that can be set using the Formula 7 below. However, in the Formula 7, the voltage amount is expressed by being converted to sensitivity.

$$Number of levels [ level ] = Log 2 ( magnification ) \qquad ( Formula 5 )$$

$$Number of levels [ level ] = Log 2 ( 1.12 ) = 0.16 \qquad ( Formula 6 )$$

At this time, if the transition amount is less than the smallest transition amount that can be set, the changes in the brightness due to the exposure changes become larger, and the user will notice the changes in the brightness due to the changes in the reverse bias voltage change less. Therefore, in a case in which the Formula 7 is valid, the number of transitions is made one time, and the transition amount is transitioned over one transition.

In the present embodiment, the transition amount of 0.16 levels is larger than the smallest transition amount that can be set of 0.1 levels, and therefore, the reverse bias voltage is transitioned by dividing the number of transitions into a plurality of times.

In this context, the transition amount is divided in half, and the number of transition times is made the divided number for when the transition amount that has been divided has become less than the smallest transition amount that can be set. In this context, 0.16 levels is divided by two, this becomes 0.08 levels, and this drops below 0.1 levels. Therefore, the transition amount for one time is made 0.08 levels and the number of transitions is made two. That is, when the voltage parameter is being transitioned, this may also be divided over a plurality of frames and transitioned.

Next, the smallest transition time that can be set when the exposure is changed will be referenced. It is preferable if the timing at which the voltage parameter is changed leaves an interval of three frames or more, which is the smallest transition time (number of frames) that can be set when the exposure is changed. This is because, provisionally, if the reverse bias voltage is transitioned at an interval of one frame, the transition speed for the exposure parameter will not keep up with this, and the changes to the brightness of the images will stand out.

Note that in both the First Embodiment and the Second Embodiment as well, in the same manner, in a case in which the number of transitions is divided into a plurality of times, it is preferable if the timing at which the voltage parameter is changed leaves an interval of three frames or more, which is the smallest transition time (number of frames) that can be set when the exposure is changed.

During step S2004, the control unit 303 changes the voltage parameter according to the transition amount and transition time for the voltage parameter that were decided during step S2003.

During step S2005, the control unit 303 determines whether or not the change to the voltage parameter has been completed. In addition, at this time, it may also be determined if the exposure is stable based on the image and the setting values for the exposure. In addition, a sufficient settling time may be provided until the exposure stabilizes, and it may be determined whether or not that settling time has elapsed.

In the case of Yes during step S2005, the processing proceeds to step S1006, and in the case of No, the processing returns to step S2004. Step S1006 to step S1008 are the same as those in FIG. 7 and therefore, explanations thereof will be omitted.

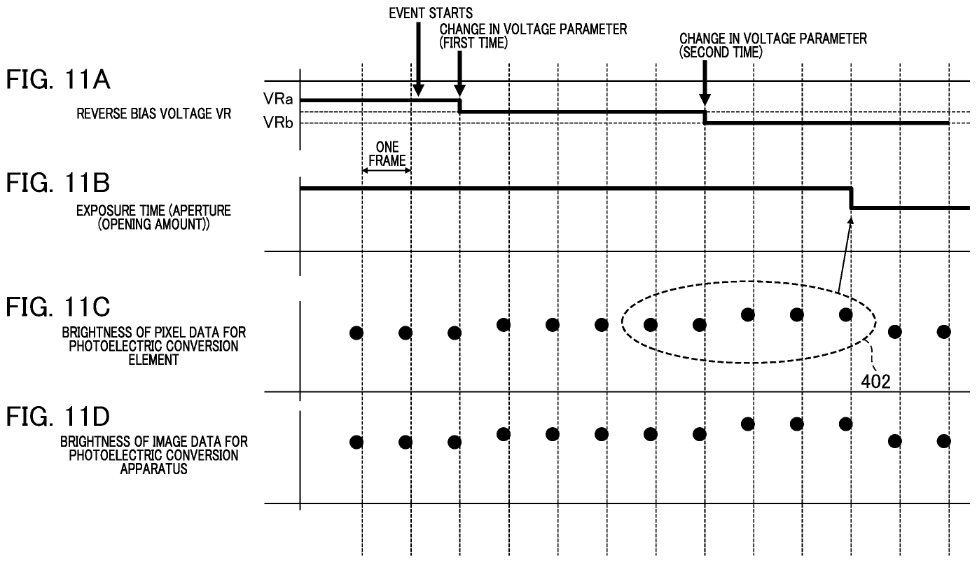

Next, the timing for changing the voltage parameter and the exposure parameter will be explained with reference to FIGS. 11 (A) to (D). FIGS. 11 (A) to (D) are diagrams explaining examples of timings for changing the voltage parameter and the exposure parameter according to the Third Embodiment.

FIG. 11 (A) is a diagram showing a waveform for the reverse bias voltage, FIG. 11 (B) is a diagram showing changes in the exposure time or the aperture opening due to changes in the exposure parameter, and FIG. 11 (C) is a diagram showing changes in the brightness of pixel data that is read out from the photoelectric conversion element 100. In addition, FIG. 11 (D) is a diagram showing changes in brightness to an image that is read out from the image capturing apparatus. The horizontal axis in FIGS. 11 (A) to (D) represents time.

FIG. 11 shows an example in which the number of transitions for the reverse bias voltage has been made two times. The first change to the voltage parameter is performed during the blank period directly before the first frame after an event is detected. Furthermore, the second change to the voltage parameter is performed during the blank period directly before a predetermined frame after having left an interval of five frames.

Although an example is shown in FIG. 11 in which the frame interval is five frames, the frame interval is not limited to five. In contrast to the changes to the voltage parameter being performed actively, the changes to the exposure parameter are performed in cases in which the brightness of an image capturing pixel of the photoelectric conversion element 100 is calculated, and the difference from the proper value (the goal brightness) is at or above a predetermined value.

In addition, in order to suppress instability of the exposure, the exposure is changed in a case in which the moving average for a plurality of frames is calculated for the calculated brightness, and the difference between the moving average and the proper value is at or above a predetermined threshold. In addition, hysteresis is held by making the above proper value different for cases in which the exposure is increased and cases in which it is decreased.

Therefore, the timing for the change in the voltage parameter and the timing for the exposure change are not necessarily the same timing. In addition, in FIG. 11, an example is shown in which the moving average for the image capturing pixel for the five frames that are enclosed by the dotted line 402 exceeds the predetermined proper value by a predetermined value or more, and the exposure time is changed so as to be shortened.

As was shown above, in the present embodiment, it becomes possible to acquire an image with a high image quality in which subject blur has been suppressed by shortening the exposure time even if the voltage parameter and the exposure parameter are asynchronous by deciding the voltage parameter based on the exposure parameter. Note that although an example has been explained in which the exposure time is shortened, this may also be a control that lowers the digital gain or increases the aperture value.

In addition, in the above explanation, although an example has been shown in which the transition amount for the reverse bias voltage is divided in half, this does not need to be half. In addition, the division of the transition amount also does not have to be even.

In addition, the smallest number of levels by which the exposure time can be changed depends on the configuration and the characteristics of the photoelectric conversion element 100, and there are also cases in which only rough settings such as one third of a level or the like can be set. In relation to this, the digital gain only changes the numerical value that is used in the operations for the image processing, and can be set to a precise number such as one tenth of a level, or the like.

Therefore, in a case in which in the Second Embodiment, the smallest number of levels by which the exposure time can be changed is rough, the same transition amount as the transition amount for the reverse bias voltage cannot be set, and a difference in the level of sensitivity occurs, this difference in the level of sensitivity can be corrected using the digital gain. That is, a difference in sensitivities that occurs in a case in which the voltage parameter is being controlled together with the control of the exposure time or the aperture value to serve as the exposure parameter may also be corrected with the digital gain.

It is thereby possible to precisely keep the brightness stable even if the reverse bias voltage is transitioned. Note that, in the above description, although a case in which the smallest number of levels by which the exposure time can be changed is rough has been explained, the same also applies to cases in which the smallest umber of levels for the control of the aperture is rough.

Note that as one example of an event, in the First Embodiment, an autofocus command was explained, and in the Second Embodiment, the detection of a moving body was explained. However, the present invention is not limited thereto. For example, changes in the brightness of the image that has been captured, the detection of/changes in an edge, or the detection of/changes in a characteristic point may also be detected as an event.

In addition, the score for image recognition such as facial recognition or the like may also be calculated, and this score exceeding a threshold may also be detected as an event. In addition, detection such as leaving detection, carrying away detection, or the like that detect a change in an image may also be detected as an event.

In addition, pan tilt zoom drive due to preset cyclic movement, which is an automatic control of the camera, pan tilt zoom drive including a tracking operation, the insertion and extraction of an infrared cut filter, or the insertion and extraction of an ND (neutral density) filter may also be detected as events. Further additionally, the switching between the on/off mode for the flash may also be detected as an event.

In addition to the photoelectric conversion element 100 as well, information that is input from a sensing device that the image capturing apparatus 300 is equipped with may also be made an event. For example, audio information that is acquired from a microphone serving as a sensing device (screaming, sounds with a loud volume, sounds with a specific frequency, or the like), or distance information that is input from a ToF (Time of Flight) sensor serving as a sensing device may also be made events.

Conversely, angular velocity information that is input from a gyro sensor serving as a sensing device, velocity information that is input from an acceleration sensor serving as a sensing device, light quantity information from a visible light sensor and an infrared light sensor that are separate from the photoelectric conversion apparatus and serve as a sensing device, or the like may also be made an event.

In addition, the processing for detecting an event based on an image that has been captured, and the application that is performed based on the event may also be performed not by the image capturing apparatus 300, but on the side of a client apparatus that is connected to the image capturing apparatus 300. The client apparatus acquires images in real time, performs image processing such as facial recognition, person counting, or the like, and may also detect events based on the results of this image processing.

In addition, in a case in which the user is performing operations in real time while viewing a camera image, an input operation from the user may also be made an event. For example, an operation command such as pan, tilt, zoom, or the like, a command for an enlarged display using electronic zoom, a command specifying an area of interest in an image, or the like may also be made an event.

Note that in a case in which the user is focused such as during enlargement with electronic zoom, a command that specifies an area of interest, or the like, display may be performed on a display apparatus of the client apparatus such as the display of for example, “increasing sensitivity” in a case in which the reverse bias voltage is being changed and the sensitivity is being increased, or the like.

Furthermore, in a case in which the user has selected each type of event, how the quality of the image that is displayed will change according to the type may also be set such that the difference in image quality can be confirmed by a comparison or switching on the screen of the display apparatus.

In addition, although an example has been shown in which the reverse bias voltage is increased in order to increase the sensitivity at the time of the detection of an event, the reverse bias voltage may also be made smaller (for example, making-31.0V-30.8V, or the like) at times other than when an event is detected in order to inhibit energy consumption.

Note that in the First Embodiment and the Second Embodiment, a unit for changing the exposure parameter according to the event or the type of control that is performed after an event may also be decided. For example, in a case in which the noise is being considered, the digital gain may be changed, in a case in which movement is being considered, the exposure time may be changed, or in a case in which blur is being considered, the aperture may be changed.

That is, by changing the digital gain, it is possible to change the noise from when image capturing is performed at the same brightness, by changing the exposure time, it is possible to change the camera shake for a subject, and by changing the aperture, it is possible to change the blur amount for a subject.

In addition, although an example was explained in which the exposure parameter was one of digital gain, exposure time, or aperture, the exposure parameter may also combine and change a plurality from among the digital gain, the exposure time, or the aperture.

In addition, the transition amount for the reverse bias voltage may also be changed according to the type of event. For example, during an event that is the detection of a moving body, this can be detected if the changes in brightness are understood, and therefore, the transition amount for the reverse bias voltage (the increase to the sensitivity) can be set to be small. In relation to this, during a facial recognition event a higher resolution image is necessary for characteristic point detection or the like, and the transition amount for reverse bias voltage (the increase in the sensitivity) is set to be large.

In addition, if the digital gain is increased, the S/N deteriorates, and therefore, by decreasing the digital gain by increasing the sensitivity due to changes in the reverse bias voltage, it is possible to acquire a high-resolution image with an increased S/N. This is particularly effective in a case in which the evaluation value is calculated using the visibility for the user or image processing.

In addition, the exposure time contributes to subject blur, and therefore, by making the exposure time short by changing the reverse bias voltage (increasing the sensitivity), it is possible to acquire a high-resolution image in which subject blur due to movement has been suppressed. In addition, in contrast to this, by making the exposure time long by changing the reverse bias voltage (decreasing the sensitivity), it is possible to capture an afterimage (a light-track image or the like) due to the movement of the subject, and a high-resolution image can be acquired.

In addition, aperture contributes to depth of field, and therefore, by performing control such that the aperture closes by changing the reverse bias voltage (increasing the sensitivity), it is possible to widen the depth of focus, and a high-resolution image in which a wide range has been image captured with a high degree of resolution can be obtained. In addition, conversely, by controlling the aperture so as to open by changing the reverse bias voltage (decreasing the sensitivity), it is possible to narrow the depth of focus, and it is possible to acquire a high-resolution image suited to portrait image capturing in which the background has been blurred.

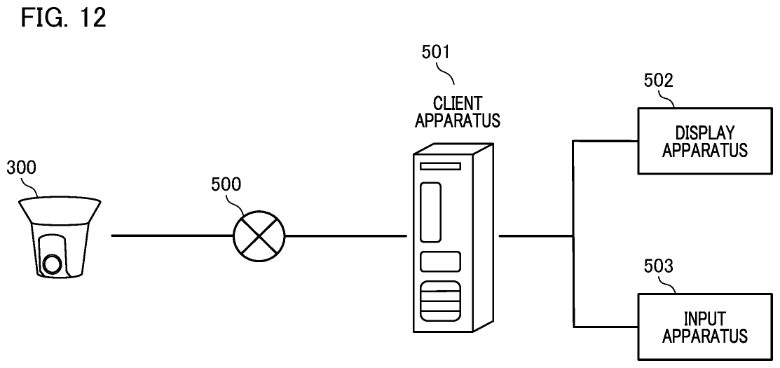

FIG. 12 is a diagram showing a configurational example of an image capturing system including the image capturing apparatus 300 according to the First Embodiment to the Third Embodiment. The image capturing system has an image capturing apparatus 300, a network 500, a client apparatus 501, a display apparatus 502 (display unit), and an input apparatus (input unit) 503.

In this manner, the image capturing system has the image capturing apparatus 300, which has a photoelectric conversion element, and a client apparatus that serves as an external apparatus that is connected to the image capturing apparatus 300 via the network 500 serving as a communication path.

The image capturing apparatus 300 can communicate with the client apparatus 501 via the network 500. The image capturing apparatus 300 performs image capturing for a subject and generates images, then transmits the captured images to the client apparatus 501 via the network 500. The client apparatus 501 is connected to the display apparatus 502 and the input apparatus 503, and the image that is sent thereto from the network 500 is displayed on the display apparatus 502.

In addition, the input apparatus 503 includes a keyboard and mouse or the like, and is used in order to operate a UI for a display apparatus that has been connected to the client apparatus 501 or the like. In addition, commands and operations to the client apparatus 501 or to the image capturing apparatus 300 via the network 500 are possible according to operations to the UI.

Note that although in the example that is shown in FIG. 12, the client apparatus 501, the display apparatus 502, and the input apparatus 503 are all separate, this may also be a configuration in which the client apparatus 501, the display apparatus 502, and the input apparatus 503 are one body, such as a note PC having a touch panel display.

In addition, it is not necessary that the image capturing apparatus 300 and the client apparatus 501 be connected via the network 500, and this may also be a configuration in which they are directly connected. Furthermore, this may also be a configuration in which a camera (the image capturing apparatus 300), the client apparatus 501, the display apparatus 502, and the input apparatus 503 are one body, such as a consumer camera having a touch panel display.

While the present invention has been described with reference to exemplary embodiments, it is to be understood that the invention is not limited to the disclosed exemplary embodiments. The scope of the following claims is to be accorded the broadest interpretation to encompass all such modifications and equivalent structures and functions.

In addition, as a part or the whole of the control according to the embodiments, a computer program realizing the function of the embodiments described above may be supplied to the image capturing apparatus or the like through a network or various storage media. Then, a computer (or a CPU, an MPU, or the like) of the image capturing apparatus or the like may be configured to read and execute the program. In such a case, the program and the storage medium storing the program configure the present invention.

For example, the present invention also includes inventions that are realized by using at least one processor or circuit configured to function as the embodiments explained above. Note that a plurality of processors may also be used and made so as to perform distributed processing.

This application claims the benefit of Japanese Patent Application No. 2023-029038, filed on Feb. 28, 2023, which is hereby incorporated by reference herein in its entirety.

What is claimed is:

1. An image capturing apparatus comprising: at least one processor; and a memory coupled to the at least one processor, the memory storing instructions that, when executed by the at least one processor, cause the at least one processor to:
control a voltage parameter relating to a reverse bias voltage of an avalanche photoelectric diode of a photoelectric conversion element;
control an exposure parameter of the photoelectric conversion element; and
control image quality of an image obtained from the photoelectric conversion element by performing, in joint operation, an increase or decrease in sensitivity of the photoelectric conversion element using the voltage parameter, and an increase or decrease in an exposure amount or digital gain of the photoelectric conversion element using the exposure parameter.

2. The image capturing apparatus according to claim 1, wherein the voltage parameter and the exposure parameter are changed according to an event type.

3. The image capturing apparatus according to claim 2, wherein the exposure parameter is changed according to the event type.

4. The image capturing apparatus according to claim 2, wherein a transition amount or a transition time of the voltage parameter is decided according to the event type.

5. The image capturing apparatus according to claim 1, wherein the voltage parameter comprises either of a transition amount or a transition time of the reverse bias voltage.

6. The image capturing apparatus according to claim 1, wherein the exposure parameter comprises either of a transition amount or a transition time of at least one of an exposure time of the photoelectric conversion apparatus, the digital gain for an image signal that has been output from the photoelectric conversion apparatus, and an aperture value for an optical system that makes an image incident on the photoelectric conversion element.

7. The image capturing apparatus according to claim 6, wherein in a case in which the voltage parameter is controlled together with controlling the exposure time or the aperture value to serve as the exposure parameter, a difference in a level of sensitivity that occurs is corrected using the digital gain.

8. The image capturing apparatus according to claim 1, wherein in a case in which a brightness of a subject is at or above a predetermined level, or an exposure time is below a predetermined time, or an aperture value is at or above a predetermined value, the voltage parameter is not transitioned.

9. The image capturing apparatus according to claim 1, wherein the voltage parameter and the exposure parameter are controlled together for the same frame.

10. The image capturing apparatus according to claim 1, wherein a transition of the voltage parameter and a transition of the exposure parameter are performed asynchronously.

11. The image capturing apparatus according to claim 1, wherein when the voltage parameter is transitioned, the transition is divided over a plurality of frames.

12. The image capturing apparatus according to claim 1, wherein a transition of the voltage parameter is returned after a predetermined time period has elapsed.

13. The image capturing apparatus according to claim 1, wherein a transition of the voltage parameter is performed in a blank period before an exposure period begins.

14. An image capturing system comprising:
the image capturing apparatus according to claim 1;
the photoelectric conversion element; and
an external apparatus connected to the image capturing apparatus via a signal path.

15. An image capturing method comprising:
controlling a voltage parameter relating to a reverse bias voltage of an avalanche photodiode of a photoelectric conversion element;
controlling an exposure parameter of the photoelectric conversion element; and
controlling image quality of an image that is obtained from the photoelectric conversion element by performing, in joint operation, an increase or decrease in a sensitivity of the photoelectric conversion element using the voltage parameter and an increase or decrease in an exposure amount or digital gain of the photoelectric conversion element using the exposure parameter.

16. A non-transitory computer-readable storage medium configured to store a computer program comprising instructions for executing following processes:
controlling a voltage parameter relating to a reverse bias voltage of an avalanche photodiode of a photoelectric conversion element;
controlling an exposure parameter of the photoelectric conversion element; and
controlling image quality of an image that is obtained from the photoelectric conversion element by performing, in joint operation, an increase or decrease in a sensitivity of the photoelectric conversion element using the voltage parameter and an increase or decrease in an exposure amount or digital gain of the photoelectric conversion element using the exposure parameter.
